(19) United States
(12) Patent Application Publication
(10) Pub. No.: US 2008/0200210 A1
(43) Pub. Date: Aug. 21, 2008

(54) MOBILE COMMUNICATION DEVICE AND BATTERY RECHARGE METHOD THEREOF

(76) Inventors: Hwang-Kiu LIM, Yongin-si (KR); Yong-Wook Kim, Seoul (KR)

Correspondence Address: Frank Chau. Esq.;F. CHAU & ASSOCIATES, LLC, 130 Woodbury Road, Woodbury, NY, 11797, US

(21) Appl. No.: 12/031,890

(22) Filed: Feb. 15, 2008

(30) Foreign Application Priority Data
Feb. 16, 2007 (KR) 2007-0016449

(51) Int. Cl. H04B 1/40

(52) U.S. Cl. 455/558; 455/573

(57) ABSTRACT

A mobile communication device includes an antenna, a SIM (subscriber identity module) card, and a battery. The antenna receives a control signal from an external device. The SIM card rectifies a charging signal of the control signal received by the antenna. The battery is charged with the rectified charging signal. The control signal may be an RF (radio frequency) control signal.

### CROSS-REFERENCE TO RELATED APPLICATIONS

This application claims priority under 35 U.S.C. §119 to Korean Patent Application No. 10-2007-0016449, filed on Feb. 16, 2007, the disclosure of which is incorporated by reference herein.

### BACKGROUND OF THE INVENTION

1. Technical Field

The present disclosure relates to a mobile communication device, and more particularly, to a mobile communication device capable of wireless recharging of its battery.

2. Discussion of Related Art

Mobile communication devices include portable devices such as personal communication service (PCS) terminals, personal digital assistants (PDA), smart phones, wireless terminals, and other devices capable of wirelessly transmitting and receiving audio, text, and video data.

Smart cards can be installed in mobile communication devices. Smart cards may include microprocessors, operating systems, security modules, or memories, which enable a smart card to perform more functions than typical magnetic cards.

A smart card is substantially more secure and smaller than a typical magnetic card. For example, a smart card may have approximately 1,000 times more data storage capacity and store data more safely that a typical smart card. Electronic money, credit cards, cash cards, and calling cards are gradually being transitioned from magnetic cards to smart cards.

Smart cards are divided into contact and non-contact type smart cards based on how they input and output data. A contact type card is physically inserted into a card reader and exchanges data with the card reader through contact terminals.

The non-contact type card does not need physical contact with a card reader. When the non-contact type card is positioned in the vicinity of an RF reader, an induction current is generated in a coil built into the card. The non-contact type card uses the induction current to wirelessly exchange data with the RF reader.

Smart cards may be used to identify subscribers for roaming service. Such smart cards may include subscriber identity module (SIM) cards that identify subscribers, universal subscriber identity module (USIM) cards, user identity module (UIM) cards, removable user identity module (RUIM) cards, etc.

The global system for mobile communication (GSM) used for mobile communication in Europe employs SIM cards for identifying subscribers. A SIM card stores data on a subscriber. The user data stored in a subscriber's SIM card is relayed through a network to the mobile communication service provider through a network when the mobile communication device is turned on. When the user's data is verified by the service provider, the user is able to use the mobile communication device.

SIM cards can also function as storage media for large capacity multimedia data devices due to their large storage capacity, signifying that SIM cards can be used as portable storage devices. The multimedia data stored on a SIM card can be played back on a mobile communication device or transmitted to an external host to be played back. Since an external host (for example, a personal computer) typically has higher capabilities than a mobile communication device, it can often edit and play back the multimedia data more quickly and conveniently.

A mobile communication device is operated by a power supply from a portable battery. Typically, a battery is recharged through a contacting method. Positive and negative terminals on the battery are respectively connected to positive and negative terminals on a charger to charge the battery.

However, in the contacting method of battery charging, deposits or corrosion of the connecting terminals can cause defective connections. Further, when a charger requires a separate cable, if the cable is not available, a battery cannot be charged.

Thus, there is a need for a mobile communication device that can charge its portable battery by transferring data wirelessly between a SIM card and an antenna.

### SUMMARY OF THE INVENTION

According to an exemplary embodiment of the present invention, a mobile communication device includes an antenna, a SIM (subscriber identity module) card, and a battery. The antenna receives a control signal from an external device. The SIM card rectifies a charging signal of the control signal received by the antenna. The battery is charged with the rectified charging signal. The control signal may be an RF (radio frequency) signal. The control signal may include a data request signal to request an output of data stored in the SIM card. The antenna may be disposed at an edge of the battery.

According to an exemplary embodiment of the present invention, a mobile communication device includes an antenna, a SIM card, a rectifier, and a battery. The antenna receives a control signal from an external device. The SIM card communicates through the antenna. The rectifier rectifies a charging signal of the control signal received by the antenna. The battery is charged with the rectified charging signal. The control signal may include a data request signal to request an output of data stored in the SIM card. The antenna may be disposed at an edge of the battery. The rectifier may be disposed in the battery.

According to an exemplary embodiment of the present invention, a method for charging a battery of a mobile communication device including a SIM card and a battery includes: receiving an RF (radio frequency) control signal, rectifying a charging signal of the received RF control signal, and charging the battery with the rectified charging signal. The RF control signal may include a data request signal to be used to request an output of data stored in the SIM card. The rectifying of the charging signal in the received RF control signal may be performed by the SIM card. The rectifying of the charging signal of the received RF control signal may be performed by a rectifier built into the battery.

According to an exemplary embodiment of the present invention, a communication systems includes a mobile communication device antenna, a SIM card, a battery, an RF reader, and a host. The mobile communication device antenna receives a control signal. The SIM card rectifies a charging signal of the control signal received by the antenna. The battery is charged with the rectified charging signal. The RF reader communicates with the mobile communication device. The host processes data transmitted and received through the RF reader. The host may receive through the RF reader charging information transmitted from the mobile communication device, and may externally display a charged state of the battery according to the received charging information. The RF reader may include a controller to send a data request signal to the SIM card. The RF reader may further include a transmitter to modulate the data request signal with the charging signal to generate the control signal.

### BRIEF DESCRIPTION OF THE FIGURES

The present invention will become readily apparent by reference to the following detailed description when considered in conjunction with the accompanying drawings wherein:

FIG. 1 is a schematic block diagram of a mobile communication according to an exemplary embodiment of the present invention;

FIG. 2 is a block diagram illustrating a data transmitting and charging process of a mobile communication device according to an exemplary embodiment of the present invention; and

FIG. 3 is a block diagram of a mobile communication device according to an exemplary embodiment of the present invention.

### DETAILED DESCRIPTION OF EXEMPLARY EMBODIMENTS

Hereinafter, exemplary embodiments of the present invention will be explained in detail with reference to the accompanying drawings. Like reference numerals are used for referring to the same or similar elements in the description and drawings.

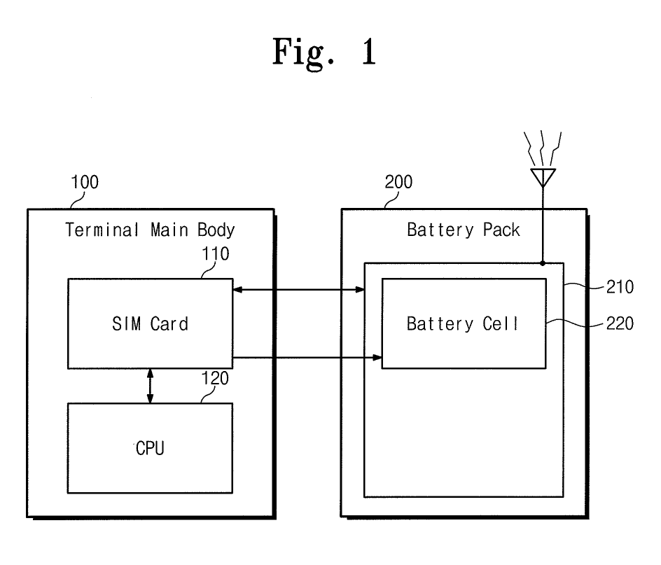

FIG. 1 is a schematic block diagram of a mobile communication according to an exemplary embodiment of the present invention. Referring to FIG. 1, the mobile communication device includes a terminal main body 100 and a battery pack 200.

The terminal main body 100 includes a central processing unit (CPU) 120 and a SIM card 110. While not shown in the diagrams, the terminal main body 110 may include other elements needed for its operation.

The CPU 120 controls the overall operation of the terminal main body 100, which includes processing and playing back of image, audio, and text data. For example, the CPU 120 may read and play pack audio and video multimedia data stored in the SIM card 110.

The SIM card 110 is inserted in a SIM card slot (not shown) built into the terminal main body 100. The SIM card 110 has a large storage capacity for storing data such as, subscriber data and multimedia data.

The battery pack 200 of the mobile communication device includes an RF antenna 210 and a battery cell 220. The RF antenna may be an RF loop antenna.

The RF antenna 210 is used for wireless communication by the SIM card 110. The illustrated RF antenna 210 is disposed inside the battery pack 200. The RF antenna 210 may also be built into the terminal main body 100.

Six of the SIM card's 110 eight terminals (not shown) may be physically connected to the terminal main body 100. The remaining two terminals of the SIM card 100 can be physically connected to the RF antenna 210.

The RF antenna 210 may be disposed at the edge of the battery pack 200. The SIM card 110 wirelessly exchanges data with an RF reader (not shown) through the RF antenna 210.

Electrical energy converted to chemical energy is stored in the battery cell 220. The battery cell 220 may be formed with a lithium ion polymer or a nickel hydroxide material.

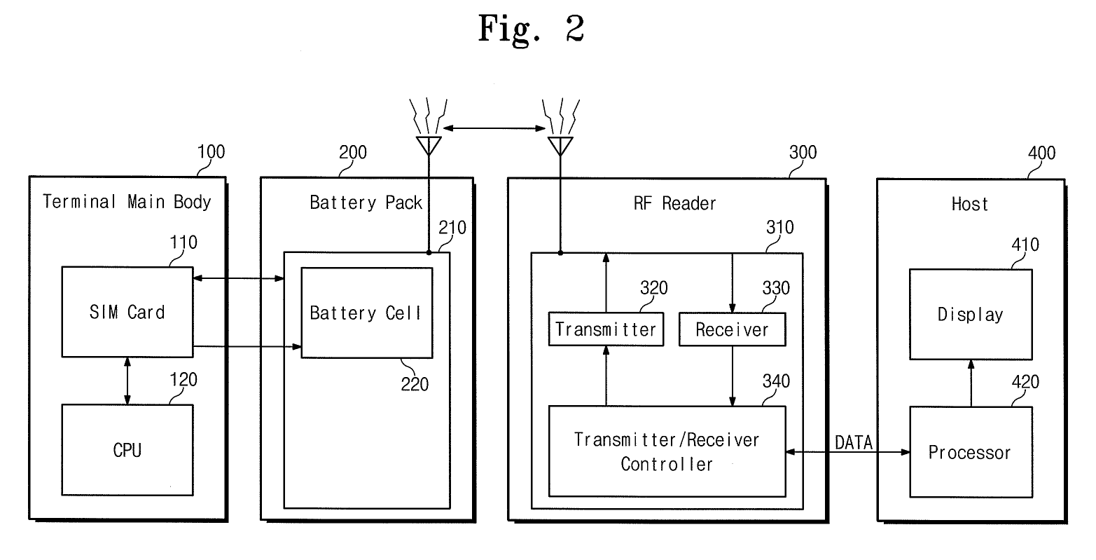

FIG. 2 is a block diagram illustrating a data transmitting and charging process of a mobile communication device according to an exemplary embodiment of the present invention. Referring to FIG. 2, an RF reader 300 includes a transmitter 320, a receiver 330, an antenna 310, and a transmitter/receiver controller 340.

To read data stored in the SIM card 110, the RF reader 300 requests a data transfer to the SIM card 110. The request may be made through a data transfer request signal.

The transmitter/receiver controller 340 generates data transfer request signals. A data transfer request signal is modulated to a control signal having a predetermined amount of energy by the transmitter 320 within the RF reader 300. The control signal is transmitted as electromagnetic waves through the atmosphere. Thus, a control signal includes the data transfer request signal and additional energy denoted as a charging signal.

When a mobile communication device is within a predetermined range of an RF reader 300, a control signal is received by the battery pack 200 of the mobile communication device through a built-in RF antenna 210. The transfer request signal and the charging signal of the control signal are relayed to the SIM card 110.

The SIM card 110 responds to the data transfer request signal and transmits data or charging information stored in the SIM card 110 from the RF antenna 210 through the atmosphere. The transmitted data is received by the antenna 310 of the RF reader 300.

The received data may be relayed through the receiver 330 and transmitter/receiver controller 340 of the RF reader 300 to a host 400 (for example, a personal computer). The signal received through the antenna 310 is demodulated in the receiver 330.

The data that is transferred to the host 400 is processed by a data processor 420 and may be output through a display 410 or a separate output device (not shown). As an example, the host 400 may edit or play back image or audio data received from the SIM card 110. The host 400 may also output charging information received from the SIM card 110 to allow a user to determine the charged state of the battery.

The RF reader 300 and the host 400 may be configured as separate devices or may be integrated into one device.

The charging signal of the control signal received by the terminal main body 100 is rectified by the SIM card 110 and supplied to the battery cell 220. The SIM card 110 may include a rectifier (not shown) that converts alternating energy to direct energy (e.g., alternating current to direct current). Rectified electrical energy may be stored in the battery cell 220 as chemical energy.

The RF reader 300 may be used to simultaneously read data from the SIM card 110 and charge the battery pack 200.

A communication system according to an exemplary embodiment of the present invention includes a mobile communication device, an RF reader, and a host.

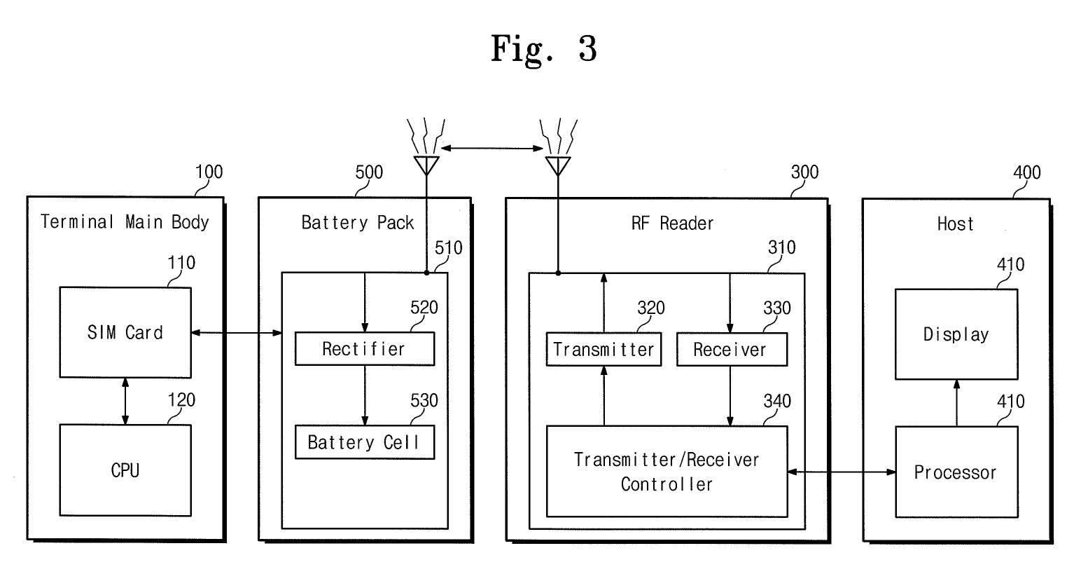

FIG. 3 is a block diagram of a mobile communication device according to an exemplary embodiment of the present invention. Referring to FIG. 3, a battery pack 500 of the mobile communication device further includes a rectifier 520. The rectifier 520 converts the charging signal in a control signal received through an RF antenna 210 from alternating current to direct current.

In the embodiment depicted in FIG. 1, the charging signal of the control signal received through the RF antenna 210 is rectified by the SIM card 110 and transferred to the battery cell 220. In the embodiment depicted in FIG. 3, the charging signal of the control signal received through the RF antenna 510 is rectified and transferred to the battery cell 530 by the rectifier 520 built into the battery pack 500.

Thus, the charging signal of the control signal may charge the battery cell 530 without being relayed through the SIM card 110.

In at least one embodiment of the present invention, the energy in the electromagnetic waves transmitted through the atmosphere by the RF reader 300 may be rectified within a battery pack 500 for charging the battery pack 500 of the mobile communication device.

Wirelessly charging the battery of a mobile communication device as described above, may be more stable and convenient than contact type charging methods.

While the present invention has been particularly shown and described with reference to exemplary embodiments thereof, it is to be understood that the present invention is not limited to these exemplary embodiments, but various changes and modifications can be made by one ordinary skilled in the art within the spirit and scope of the present invention.

What is claimed is:

1. A mobile communication device comprising:
an antenna receiving a control signal from an external device;
a SIM (subscriber identity module) card rectifying a charging signal of the control signal received by the antenna; and
a battery charged with the rectified charging signal.

2. The mobile communication device of claim 1, wherein the antenna is an RF antenna and the control signal is an RF (radio frequency) signal.

3. The mobile communication device of claim 1, wherein the battery includes a battery cell comprising one of a lithium ion polymer or a nickel hydroxide material.

4. The mobile communication device of claim 1, wherein the control signal includes a data request signal that is used to request an output of data stored in the SIM card.

5. The mobile communication device of claim 1, wherein the antenna is disposed at an edge of the battery.

6. A mobile communication device comprising:
an antenna receiving a control signal from an external device;
a SIM (subscriber identity module) card communicating through the antenna;
a rectifier to rectify a charging signal of the control signal, wherein the control signal is received by the antenna; and
a battery charged with the rectified charging signal.

7. The mobile communication device of claim 6, wherein the antenna is an RF (radio frequency) antenna and the control signal is an RF signal.

8. The mobile communication device of claim 6, wherein the battery includes a battery cell comprising one of a lithium ion polymer or a nickel hydroxide material.

9. The mobile communication device of claim 6, wherein the control signal includes a data request signal that is used to request an output of data stored in the SIM card.

10. The mobile communication device of claim 6, wherein the antenna is disposed at an edge of the battery.

11. The mobile communication device of claim 6, wherein the rectifier is disposed in the battery.

12. A method for charging a battery of a mobile communication device including a SIM card and the battery, the method comprising:
receiving an RF (radio frequency) control signal;
rectifying a charging signal of the received RF control signal; and
charging the battery with the rectified charging signal.

13. The method of claim 12, further comprising using a data request signal of the RF control signal to request an output of data stored in the SIM card.

14. The method of claim 12, wherein the rectifying of the charging signal in the received RF control signal is performed by the SIM card.

15. The method of claim 12, wherein the rectifying of the charging signal in the received RF control signal is performed by a rectifier built into the battery.

16. A communication system comprising:
a mobile communication device antenna to receive a control signal;
a SIM (subscriber identity module) card rectifying a charging signal of the control signal received by the antenna;
a battery charged with the rectified charging signal;
an RF (radio frequency) reader communicating with the mobile communication device antenna; and
a host processing data transmitted and received through the RF reader.

17. The communication system of claim 16, wherein the host receives through the RF reader charging information transmitted from the mobile communication device, and externally displays a charged state of the battery according to the received charging information.

18. The communication system of claim 16, wherein the RF reader comprises a controller to send a data request signal to the SIM card.

19. The communication system of claim 18, wherein the RF reader further comprises a transmitter to modulate the data request signal with the charging signal to generate the control signal.

20. The communication system of claim 16, wherein the control signal is an RF signal.
